(19) United States
(12) Patent Application Publication
(10) Pub. No.: US 2020/0174458 A1
(43) Pub. Date: Jun. 4, 2020

(54) METHOD TO PRESENT A USER WITH A MENU OF RANKED BUILDING SYSTEM BASED UPON USAGE OF BUILDING SYSTEMS

(71) Applicant: Carrier Corporation, Palm Beach Gardens, FL (US)

(72) Inventor: Jason Higley, Pittsford, NY (US)

(21) Appl. No.: 16/636,417

(22) PCT Filed: Aug. 20, 2018
(86) PCT No.: PCT/US2018/047046

§ 371 Date: Feb. 4, 2020

Related U.S. Application Data
(60) Provisional application No. 62/547,624, filed on Aug. 18, 2017.

(51) Int. Cl. G05B 19/418; G05B 15/02

(52) U.S. Cl. CPC G05B 19/41865; G05B 2219/25011; G05B 2219/163; G05B 15/02

(57) ABSTRACT

A method of controlling a building system is provided. The method comprising: detecting a first current position of a user device; obtaining a building system list including building systems adjustable at the first current position; obtaining an action request list including action requests transmitted from the user device to the building system at the first current position; ranking the building systems on the building system list in response to the action request list; and transmitting a ranked building systems list to the user device.

### BACKGROUND

The subject matter disclosed herein generally relates to the field of building systems, and more particularly to an apparatus and method for controlling building systems.

Existing building systems may allow for control of building systems through a user device but do not personalize the control to each user.

BRIEF SUMMARY

According to one embodiment, a method of controlling a building system is provided. The method comprising: detecting a first current position of a user device; obtaining a building system list including building systems adjustable at the first current position; obtaining an action request list including action requests transmitted from the user device to the building system at the first current position; ranking the building systems on the building system list in response to the action request list; and transmitting a ranked building systems list to the user device.

In addition to one or more of the features described above, or as an alternative, further embodiments may include: receiving a user input from the user device at the current first position, wherein the user input selects an action request for a building system; and adjusting the building system in response to the action request.

In addition to one or more of the features described above, or as an alternative, further embodiments may include detecting one or more current positions of a user device; obtaining a building system list at each of the one or more current positions, the building system list including building systems adjustable at each of the one or more current positions; receiving a user input from the user device at each of the one or more current positions, wherein the user input selects an action request for a building system; and generating an action request list in response to the action request for each of the one or more current positions.

In addition to one or more of the features described above, or as an alternative, further embodiments may include that the building systems on the building systems list are ranked in descending order of a quantity of action requests received by each building system on the building system list.

In addition to one or more of the features described above, or as an alternative, further embodiments may include that the building systems on the building systems list are ranked in descending order of a date that an action request was last received by each building system on the building system list.

In addition to one or more of the features described above, or as an alternative, further embodiments may include: adjusting the building system in response to the action request for each of the one or more current positions.

In addition to one or more of the features described above, or as an alternative, further embodiments may include that the first current position occurs at a time after each of the one or more current positions.

According to another embodiment, a building control system is provided. The building control system comprising: a processor; and a memory comprising computer-executable instructions that, when executed by the processor, cause the processor to perform operations, the operations comprising: detecting a first current position of a user device; obtaining a building system list including building systems adjustable at the first current position; obtaining an action request list including action requests transmitted from the user device to the building system at the first current position; ranking the building systems on the building system list in response to the action request list; and transmitting a ranked building systems list to the user device.

In addition to one or more of the features described above, or as an alternative, further embodiments may include that the operations further comprise: receiving a user input from the user device at the current first position, wherein the user input selects an action request for a building system; and adjusting the building system in response to the action request.

In addition to one or more of the features described above, or as an alternative, further embodiments may include that the operations further comprise: detecting one or more current positions of a user device; obtaining a building system list at each of the one or more current positions, the building system list including building systems adjustable at each of the one or more current positions; receiving a user input from the user device at each of the one or more current positions, wherein the user input selects an action request for a building system; and generating an action request list in response to the action request for each of the one or more current positions.

In addition to one or more of the features described above, or as an alternative, further embodiments may include that the operations further comprise: the building systems on the building systems list are ranked in descending order of a quantity of action requests received by each building system on the building system list.

In addition to one or more of the features described above, or as an alternative, further embodiments may include that the operations further comprise: the building systems on the building systems list are ranked in descending order of a date that an action request was last received by each building system on the building system list.

In addition to one or more of the features described above, or as an alternative, further embodiments may include that the operations further comprise: adjusting the building system in response to the action request for each of the one or more current positions.

In addition to one or more of the features described above, or as an alternative, further embodiments may include that the first current position occurs at a time after each of the one or more current positions.

According to another embodiment, a computer program product tangibly embodied on a computer readable medium is provided. The computer program product including instructions that, when executed by a processor, cause the processor to perform operations comprising: detecting a first current position of a user device; obtaining a building system list including building systems adjustable at the first current position; obtaining an action request list including action requests transmitted from the user device to the building system at the first current position; ranking the building systems on the building system list in response to the action request list; and transmitting a ranked building systems list to the user device.

In addition to one or more of the features described above, or as an alternative, further embodiments may include that the operations further comprise: receiving a user input from the user device at the current first position, wherein the user input selects an action request for a building system; and adjusting the building system in response to the action request.

In addition to one or more of the features described above, or as an alternative, further embodiments may include that the operations further comprise: detecting one or more current positions of a user device; obtaining a building system list at each of the one or more current positions, the building system list including building systems adjustable at each of the one or more current positions; receiving a user input from the user device at each of the one or more current positions, wherein the user input selects an action request for a building system; and generating an action request list in response to the action request for each of the one or more current positions.

In addition to one or more of the features described above, or as an alternative, further embodiments may include that the operations further comprise: the building systems on the building systems list are ranked in descending order of a quantity of action requests received by each building system on the building system list.

In addition to one or more of the features described above, or as an alternative, further embodiments may include that the operations further comprise: the building systems on the building systems list are ranked in descending order of a date that an action request was last received by each building system on the building system list.

In addition to one or more of the features described above, or as an alternative, further embodiments may include that the operations further comprise: adjusting the building system in response to the action request for each of the one or more current positions.

In addition to one or more of the features described above, or as an alternative, further embodiments may include that the first current position occurs at a time after each of the one or more current positions.

Technical effects of embodiments of the present disclosure include monitoring a person's use of buildings systems, ranking the building systems in response to the use, and displaying the ranked building systems on a user device through which the user may adjust the building system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

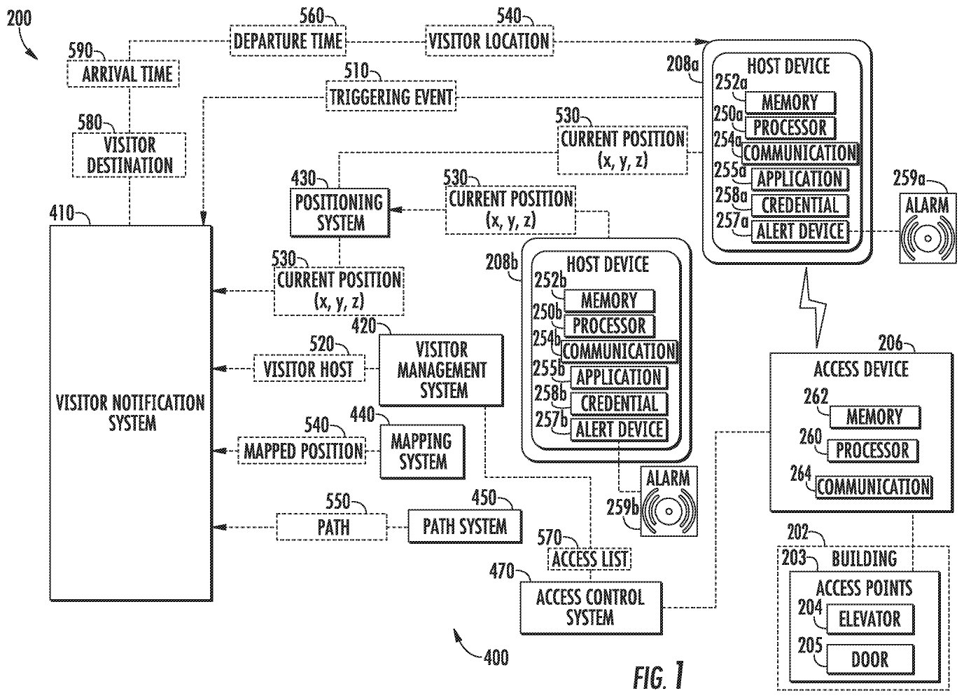

FIG. 1 illustrates a schematic view of a building control system, in accordance with an embodiment of the disclosure; and

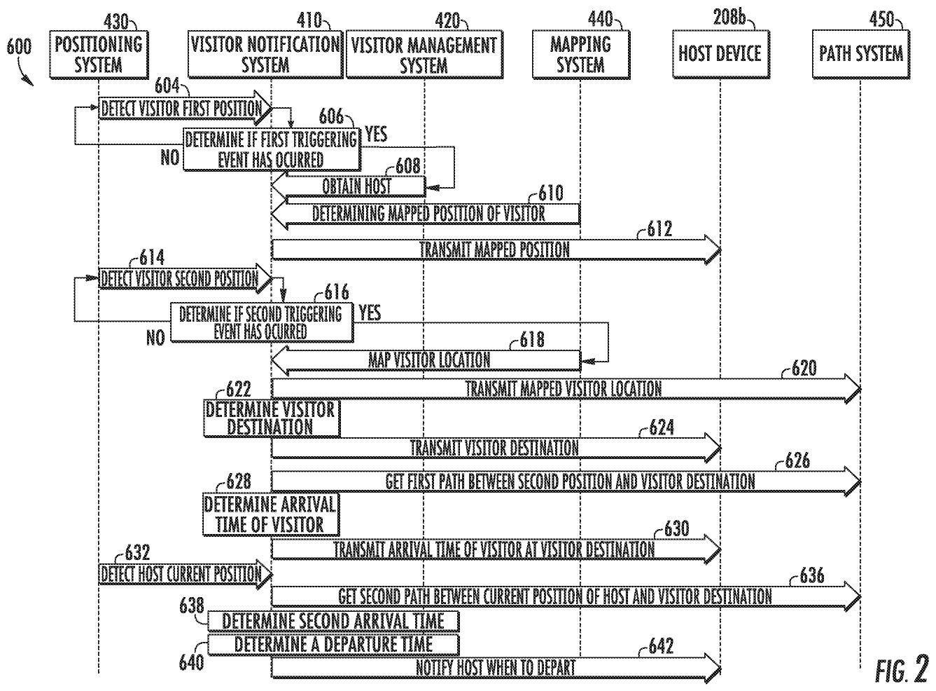

FIG. 2 is a flow diagram illustrating a method of controlling building systems, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 depicts a building control system 200 in an example embodiment. The building control system 200 includes a user device 208. The user device 208 is capable of secure bi-directional communication with a control device 206, a positioning system 430, and a plurality of interconnected systems 400. The user device 208 may be a computing device such as a desktop computer. The user device 208 may also be a mobile computing device that is typically carried by a person, such as, for example a phone, PDA, smart watch, tablet, laptop, etc. The user device 208 may also be two separate devices that are synced together such as, for example, a cellular phone and a desktop computer synced over an internet connection. The user device 208 may include a processor 250, memory 252 and communication module 254 as shown in FIG. 1. The processor 250 can be any type or combination of computer processors, such as a microprocessor, microcontroller, digital signal processor, application specific integrated circuit, programmable logic device, and/or field programmable gate array. The memory 252 is an example of a non-transitory computer readable storage medium tangibly embodied in the user device 208 including executable instructions stored therein, for instance, as firmware. The communication module 254 may implement one or more communication protocols as described in further detail herein. The user device 208 is configured to store a unique credential 258 that may be shared with the control device 206 and a plurality of interconnected systems 400, discussed further below. In a non-limiting example, the user device 208 may belong to an employee and/or resident of the building 202. The user device 208 may include an alert device 257 configured to activate an alarm 259. In three non-limiting examples, the alert device 257 may be a vibration motor, audio speaker, and/or display screen. The alarm 259 may be audible, visual, haptic, and/or vibratory. The user device 208 may also include an application 255. Embodiments disclosed herein, may operate through the application 255 installed on the user device 208.

As shown in FIG. 1, the building control system 200 also includes a plurality of interconnected systems 400 including: a positioning system 430, an audit system 460, one or more building systems 470, a mapping system 440, and a prioritization system 410. In the illustration of FIG. 1, the interconnected systems 400 are illustrated as separate systems. In an embodiment, at least one of the positioning system 430, the audit system 460, the one or more building systems 470, the mapping system 440, and the prioritization system 410 may be combined into a single system. In another embodiment, at least one of the positioning system 430, the audit system 460, the one or more building systems 470, the mapping system 440, and the prioritization system 410 is within the user device 208.

The interconnected systems 400 may each include a processor, memory and communication module. For ease of illustration, the processor, memory, and communication module are not shown in FIG. 1. The processor can be any type or combination of computer processors, such as a microprocessor, microcontroller, digital signal processor, application specific integrated circuit, programmable logic device, and/or field programmable gate array. The memory is an example of a non-transitory computer readable storage medium tangibly embodied in or operably connected to the path determination system including executable instructions stored therein, for instance, as firmware. The communication module may implement one or more communication protocols as described in further detail herein.

The positioning system 430 is configured to determine a current position 530 of the user device 208. The current position 530 includes the (x, y, z) coordinates of the user device 208 on a map. The (x, y, z) coordinates may translate to a latitude, a longitude, and an elevation. The positioning system 430 may use various methods in order to determine the current position 530 of the user device 208 such as, for example, GPS, Bluetooth triangulation, Wi-Fi triangulation, cellular signal triangulation, or any other location determination method known to one of skill in the art. The positioning system 430 is configured to transmit the current position 530 to the user device 208 and at least one of the prioritization system 410 and the mapping system 440. The prioritization system 410 and the audit system 460 is configured to receive the current position 530 from the positioning system 430.

The mapping system 440 is configured to store the (x, y, z) coordinates of control devices 206. When the mapping system 440 is provided with the current position 530 of a user device, the mapping system 440 is configured determine a building system list 540 in response to the current position 540. The building systems list 540 includes what the building systems 470 a user may have access to depending upon the current position 530. For example, if a user enters conference room A, the current position 530 show that the user is in Conference Room A and the mapping system 440 will determine all the building systems 470 available to the user in conference room A in a building systems list 540. The building systems list 540 may then be displayed upon the user device 208 through an application 255 and the user may select a building system 470 to control on the building systems list 540 through the application 255.

The building system 470 may include one or more individual controlled building systems including but not limited to lights, thermostat, blinds, cabinet locks, computers . . . etc. The building system 470 is configured to receive an action request 510 from the user device 208 and then adjust the building system 470 in response to the action request 510. In one example, the action request 510 may be to dim the lights and thus the building system may dim the lights in response to the action requests 510. The building control system 200 includes at least one control device 206 to adjust the building systems 206. The adjustments may include but is not limited to turning lights on/off, adjusting the strength of lights, adjusting the color of lights, increasing/decreasing the temperatures, opening/closing the blinds, powering on/off a computer . . . etc. The building systems 470 may be installed at a building 202. In some embodiments, the building 202 may be a building or a collection of buildings that may or may not be physically located near each other. The building 202 may include any number of floors.

Each of the action requests 510 are transmitted from the building system 470 to the audit system 460. The audit system 460 is configured to receive and store the action requests 460. The audit system 460 is also configured to transmit a list of action requests 520 to the prioritization system 410 when requested. The building systems 470 may be operably connected to one or more control devices 206 configured to control the building system 470.

The control device 206 may include a processor 260, memory 262 and communication module 264 as shown in FIG. 1. The processor 260 can be any type or combination of computer processors, such as a microprocessor, microcontroller, digital signal processor, application specific integrated circuit, programmable logic device, and/or field programmable gate array. The memory 262 is an example of a non-transitory computer readable storage medium tangibly embodied in the control device 206 including executable instructions stored therein, for instance, as firmware. The memory 262 may store a unique device ID for each control device 206. The memory 262 may also store a set of geo-location information for each control device 206. The communication module 264 allows for secure bi-directional communication wirelessly with a user device 208. The communication module 264 may implement one or more communication protocols as described in further detail herein.

The user device 208 communicates with the control device 206 and the interconnected systems 400. The communication may occur over a wireless network, such as 802.11x (Wi-Fi), short-range radio (Bluetooth), cellular, satellite, etc. In some embodiments, an interconnected system 400 and the control device 206 may include, or be associated with (e.g., communicatively coupled to) a networked system, such as kiosk, beacon, lantern, bridge, router, network node, building intercom system, etc. The networked system may communicate with the user device 208 using one or more communication protocols or standards. For example, the networked system may communicate with the user device 208 using near field communications (NFC). In an embodiment, the user device 208 may communicated with a control device 206 through a networked system. In other embodiments, the user device 208 may establish communication with an interconnected system 400 or a control device 206 that is not associated with a networked system in the building 202. This connection may be established with various technologies including GPS, 802.11x (Wi-Fi), cellular, or satellite, by way of non-limiting example. In example embodiments, the user device 208 communicates over multiple independent wired and/or wireless networks. Embodiments are intended to cover a wide variety of types of communication between the user device 208, the control device 206 and interconnected system 400, thus embodiments are not limited to the examples provided in this disclosure.

Referring now to FIG. 2, while referencing components of FIG. 1. FIG. 2 shows a flow chart of method 600 of controlling building systems, in accordance with an embodiment of the disclosure. The method 600 is composed of two segments include a data collection segment 610 and a data application segment 630.

The data collection segment 610 collects data so that the data application segment 630 may be conducted with increased accuracy. The data collection segment 610 may be repeated multiple times and thus the terms “one or more” may be used when discussing the current position 530 during the data collection segment. Moreover, the data collection segment 610 and the data application segment 630 may occur simultaneously and may overlap.

The data collection segment 610 comprises blocks 612-626. At block 612, one or more current positions 530 of a user device 208 are detected. As mentioned above, the “one or more” term is meant to illustrate the repetitive nature of the blocks 612-626, thus each of the one or more current positions 530 are detected at a different time. The one or more current positions 530 of the user device 208 may be detected by the positioning system 430 and transmitted to the prioritization system 410 and/or the mapping system 420. If each of the one or more current positions 530 are transmitted to the prioritization system 410 then the prioritization system 410 will transmit each of the one or more current positions 530 to the mapping system 420 at block 614 in order to obtain a building system list 540 at each of the one or more current positions 530a at block 616. The building system list 540 includes building systems 470 adjustable at each of the one or more current positions 530. At block 618, the building system list 540 is transmitted to the user device 208 to be displayed on a display screen of the user device 208. At block 620, a user input from the user device 208 is received at each of the one or more current positions 530. The user input selects an action request 510 for a building system 470. The user input may be a touch to a touch screen of the user device 208, a click of a button of the user device 208, a voice command on the user device 208, or any other method of signaling intent to a computing device known to one of skill in the art.

At block 622, the action request 510 is transmitted to the building system 470 selected by the user input. At block 624, the building system 470 is adjusted in response to the action request 510. In an example, the action request 510 may indicate to turn on the lights and thus the lights will turn on in response to the action request 510. At block 626, the action request is logged in the audit system 460. The audit system 460 is configured to generate an action request list 520 in response to the action requests 510 for each of the one or more current positions. The action request list 520 will continue to grow, the more the data collection segment 610 is repeated.

The data application segment 630 comprises blocks 631-648. The data application segment 630 utilizes the data collected for the one or more current positions 530 and then applies that data to a single first current position 530 of the user device 208. Is important to understand the single first current position 530 may also be used for the purposes of the data collection segment 610 to first refine ranking in response to the action request list 520 described further below. The first current position 530 occurs at a time after each of the one or more current positions 530.

At block 631, a first current position 530 of a user device 208 is detected. The first current position 530 of the user device 208 may be detected by the positioning system 430 and transmitted to the prioritization system 410 and/or the mapping system 420. If the first current position 530 is transmitted to the prioritization system 410 then the prioritization system 410 will transmit the first current position 530 to the mapping system 420 at block 632 in order to obtain a building system list 540 at the first current position 530 at block 634. The building system list 540 includes building systems 470 adjustable at the first current position 530.

At block 636, the action request list 520 is obtained from the audit system 460. The action request list includes action requests 510 transmitted from the user device 208 to the building system 770 at the first current position 530. The action request list 520 was composed during the data collection segment 610. At block 640, the building systems 470 on the building system list 540 are ranked in response to the action request list 520. The building systems 470 on the building system list 540 may be ranked in descending order of a quantity of action requests 510 received by each building system 470 on the building system list 540, thus the building system 470 being used the most may appear first. The building systems 470 on the building system list 540 may be ranked in descending order of a date that an action request 510 was last received by each building system 470 on the building system list 540, thus the building system 470 used the most recently may appear first.

At block 642, the ranked building system list 550 is transmitted to the user device 208 to be displayed on a display screen of the user device 208. At block 644, a user input from the user device is received at the first current position 530. The user input selects an action request 510 for a building system 470. The user input may be a touch to a touch screen of the user device 208, a click of a button of the user device 208, a voice command on the user device 208, or any other method of signaling intent to a computing device known to one of skill in the art. At block 646, the action request 510 is transmitted to the building system 470 selected by the user input. At block 648, the building system 470 is adjusted in response to the action request 510. The data application segment 630 may also include a block where the action request 510 is logged, similar to block 626.

While the above description has described the flow process of FIG. 2 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of controlling a building system, the method comprising:
detecting a first current position of a user device;
obtaining a building system list including building systems adjustable at the first current position;
obtaining an action request list including action requests transmitted from the user device to the building system at the first current position;
ranking the building systems on the building system list in response to the action request list; and
transmitting a ranked building systems list to the user device.

2. The method of claim 1, further comprising:
receiving a user input from the user device at the current first position, wherein the user input selects an action request for a building system; and
adjusting the building system in response to the action request.

3. The method of claim 1, further comprising:
detecting one or more current positions of a user device;
obtaining a building system list at each of the one or more current positions, the building system list including building systems adjustable at each of the one or more current positions;
receiving a user input from the user device at each of the one or more current positions, wherein the user input selects an action request for a building system; and
generating an action request list in response to the action request for each of the one or more current positions.

4. The method of claim 1, wherein:
the building systems on the building systems list are ranked in descending order of a quantity of action requests received by each building system on the building system list.

5. The method of claim 1, wherein:
the building systems on the building systems list are ranked in descending order of a date that an action request was last received by each building system on the building system list.

6. The method of claim 3, further comprising:
adjusting the building system in response to the action request for each of the one or more current positions.

7. The method of claim 3, wherein:
the first current position occurs at a time after each of the one or more current positions.

8. A building control system comprising:
a processor; and
a memory comprising computer-executable instructions that, when executed by the processor, cause the processor to perform operations, the operations comprising:
detecting a first current position of a user device;
obtaining a building system list including building systems adjustable at the first current position;
obtaining an action request list including action requests transmitted from the user device to the building system at the first current position;
ranking the building systems on the building system list in response to the action request list; and
transmitting a ranked building systems list to the user device.

9. The building control system of claim 8, wherein the operations further comprise:
receiving a user input from the user device at the current first position, wherein the user input selects an action request for a building system; and
adjusting the building system in response to the action request.

10. The building control system of claim 8, wherein the operations further comprise:
detecting one or more current positions of a user device;
obtaining a building system list at each of the one or more current positions, the building system list including building systems adjustable at each of the one or more current positions;
receiving a user input from the user device at each of the one or more current positions, wherein the user input selects an action request for a building system; and
generating an action request list in response to the action request for each of the one or more current positions.

11. The building control system of claim 8, wherein the operations further comprise:
the building systems on the building systems list are ranked in descending order of a quantity of action requests received by each building system on the building system list.

12. The building control system of claim 8, wherein the operations further comprise:
the building systems on the building systems list are ranked in descending order of a date that an action request was last received by each building system on the building system list.

13. The building control system of claim 10, wherein the operations further comprise:
adjusting the building system in response to the action request for each of the one or more current positions.

14. The method of claim 10, wherein:
the first current position occurs at a time after each of the one or more current positions.

15. A computer program product tangibly embodied on a computer readable medium, the computer program product including instructions that, when executed by a processor, cause the processor to perform operations comprising:
detecting a first current position of a user device;
obtaining a building system list including building systems adjustable at the first current position;
obtaining an action request list including action requests transmitted from the user device to the building system at the first current position;
ranking the building systems on the building system list in response to the action request list; and
transmitting a ranked building systems list to the user device.

16. The computer program product of claim 15, wherein the operations further comprise:
receiving a user input from the user device at the current first position, wherein the user input selects an action request for a building system; and
adjusting the building system in response to the action request.

17. The computer program product of claim 15, wherein the operations further comprise:
detecting one or more current positions of a user device;
obtaining a building system list at each of the one or more current positions, the building system list including building systems adjustable at each of the one or more current positions;
receiving a user input from the user device at each of the one or more current positions, wherein the user input selects an action request for a building system; and
generating an action request list in response to the action request for each of the one or more current positions.

18. The computer program product of claim 15, wherein the operations further comprise:
the building systems on the building systems list are ranked in descending order of a quantity of action requests received by each building system on the building system list.

19. The computer program product of claim 15, wherein the operations further comprise:
the building systems on the building systems list are ranked in descending order of a date that an action request was last received by each building system on the building system list.

20. The computer program product of claim 17, wherein the operations further comprise:
adjusting the building system in response to the action request for each of the one or more current positions.

21. (canceled)
